(19) United States
(12) Patent Application Publication
(10) Pub. No.: US 2008/0101575 A1
(43) Pub. Date: May 1, 2008

(54) PARTICIPANT PRIORITIZATION ON TELEPHONE CONFERENCE CALLS

(76) Inventors: Erick Simon Amador, Miramar, FL (US); Gregory Jensen Boss, American Fork, UT (US); Peter George Finn, Brampton (CA); Rick Allen Hamilton, Charlottesville, VA (US)

Correspondence Address: IBM CORP (YA);C/O YEE & ASSOCIATES PC, P.O. BOX 802333, DALLAS, TX, 75380, US

(21) Appl. No.: 11/554,816

(22) Filed: Oct. 31, 2006

(51) Int. Cl. H04M 3/42

(52) U.S. Cl. 379/202.01

(57) ABSTRACT

A computer implemented method and a computer program product for prioritizing a participant in a teleconference are provided. Participants in a teleconference are prioritized in order to manage the participants currently speaking and participants wanting to interrupt. A participant has an individual or a group priority level associated with the participant, which is communicated to a teleconference system. When the participant indicates a desire to interrupt a currently speaking participant, the teleconference system compares the priorities of the participant and the currently speaking participant. If the participant has the priority necessary for the interruption, the teleconference system grants the participant an ability to interrupt the teleconference. Using this ability, the participant can interrupt a currently speaking participant who has a lower priority than that of the participant, interrupt a currently speaking participant with higher priority under certain circumstances, or become an exclusive speaker for a duration or a topic.

### BACKGROUND OF THE INVENTION

1. Field of the Invention

The illustrative embodiment relates generally to an improved data processing system, and in particular, to a computer implemented method and apparatus for managing telephone conference calls. Still more particularly, the illustrative embodiment is directed to a computer implemented method and apparatus for managing participants on telephone conference calls.

2. Description of the Related Art

When several participants have to communicate with each other in a collective manner via telephone, a person-to-person telephone call system does not work beyond two or three participants. A teleconference is a voice communications session in which several participants are simultaneously connected with each other over a network. Presently available technology allows the use of telephones as well as computers to participate in a teleconference. Participants using telephones use telephone networks and participants using computers use data networks to participate in teleconferences. Hybrid devices that act as a telephone as well as a computer can participate using a mix of telephone and data networks.

Teleconferences are a method of choice for communicating simultaneously with geographically dispersed participants. Using teleconferencing, several participants can simultaneously connect with one another and converse without being required to be present in one common place.

Teleconference-bridge technology is available to conduct a teleconference in a hub and spoke manner. Teleconference-bridge technology is commonly known as a “bridge”. In a teleconference that utilizes a bridge, the bridge acts as a hub, and all participants call the bridge forming several participant-to-bridge connections like the spokes of a wheel. The bridge then provides connectivity between each participant in the teleconference to the other from its central hub role.

One manner in which a teleconference is different from a person-to-person telephone call is that several participants can speak simultaneously. When several participants talk at once, the teleconference can become noisy and annoying. Several factors, including technological factors, contribute to this teleconferencing problem. Some participants may be using a speakerphone that allows local side-discussions to be introduced into the teleconference, while other participants using cell phones may inadvertently introduce ambient noise. Some participants may be using a device that does not support full-duplex communication, such as some voice-enabled computer chat applications. Full-duplex functionality allows a participant to speak and hear other participants at the same time. Absent full-duplex functionality in a device, a speaking participant using that device may be oblivious to another participant trying to speak, resulting in two participants speaking on the teleconference at once.

### SUMMARY OF THE INVENTION

The illustrative embodiments provide a data processing system and a computer implemented method for managing a teleconference. The computer implemented method identifies priority levels for several participants. A currently speaking participant is identified and the teleconference is monitored for an indication by another participant who may desire to interrupt the currently speaking participant. When such an indication is observed, the priority levels of the currently speaking participant and the interrupting participant are compared. Depending on the result of the comparison, the interrupting participant is selectively allowed to interrupt the currently speaking participant.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems and telephones in a teleconference in which illustrative embodiments may be implemented;

FIG. 2 is a block diagram of a data processing system in accordance with an advantageous embodiment;

FIG. 3 is a block diagram of a teleconferencing system in accordance with an illustrative embodiment;

FIG. 4 is a message flow diagram of the process for determining and changing participant priority in accordance with an illustrative embodiment; and

FIG. 5 is a flowchart of the process of managing interruptions in a teleconference using participant priority in accordance with an illustrative embodiment.

### DETAILED DESCRIPTION OF THE PREFERRED EMBODIMENT

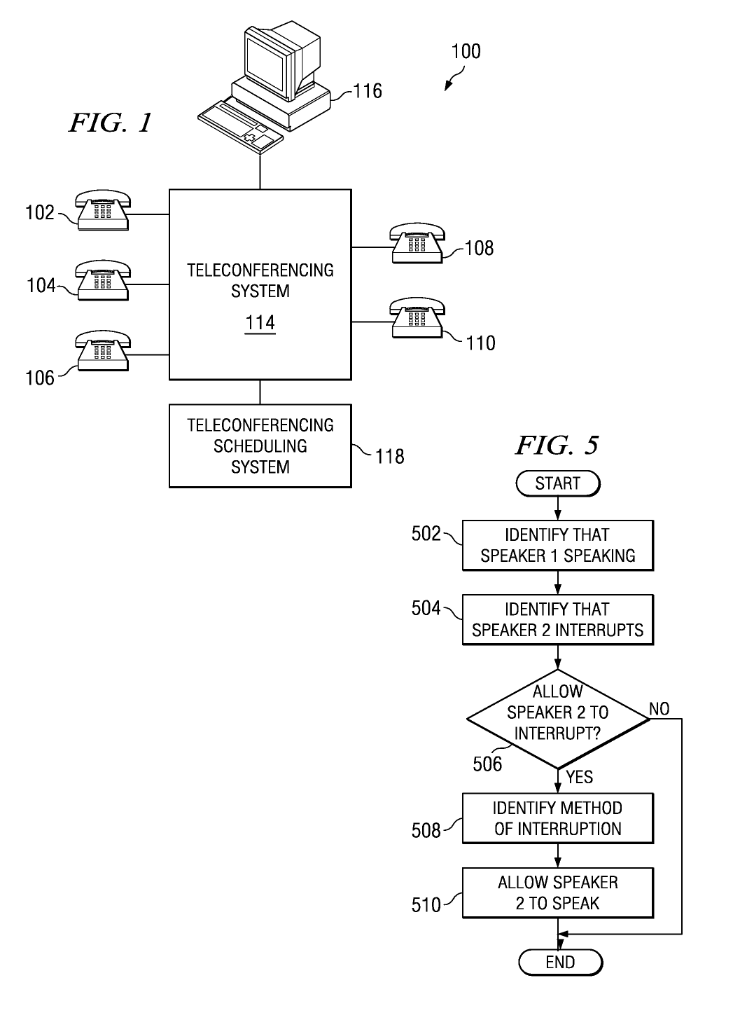

With reference now to the figures, FIG. 1 depicts a pictorial representation of a network of data processing systems and telephones in a teleconference in which illustrative embodiments may be implemented. Telephones 102-110 represent participants who are using telephone equipment to connect to teleconferencing system 114. Any number of such participants may join in a teleconference. Furthermore, a variety of telephone equipment is commonly available, such as wired telephones, wireless telephones, and mobile or cellular telephones, and any such equipment may be used for participating in teleconferences.

Data processing system 116 can also join in a teleconference by connecting to the teleconferencing system using hardware and software designed to enable such participation. Teleconference scheduling system 118 is a data processing system that can be used for setting a time for the teleconference, inviting participants, and other teleconference scheduling functions. Teleconference scheduling system 118 communicates with teleconferencing system 114 to deliver the scheduling information. Teleconference system can utilize the scheduling information for conducting the teleconference.

Note that five telephones 102-110 and one data processing system 116 are shown for the simplification of the illustration in FIG. 1, and not to imply any limitation on the illustrative embodiment. Furthermore, more than one teleconferencing system, such as teleconferencing system 114 may jointly conduct a teleconference. For example, if a teleconference has participants in the United States, Canada, France, and Germany, the participants in a specific country may connect to a teleconferencing system in that country to save international telephone charges, and the teleconferencing systems in each country can coordinate among themselves the conducting of the teleconference.

Further note that single teleconference scheduling system 118 is shown for the simplicity of illustration. One or more such systems may communicate with one or more teleconferencing systems to schedule and conduct a teleconference.

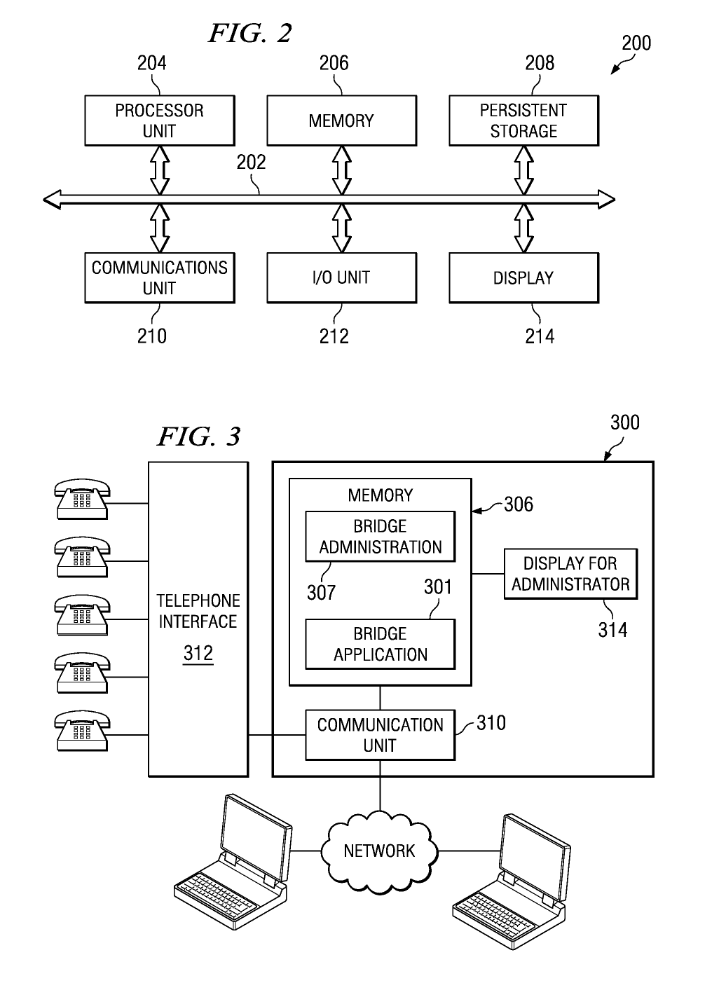

Turning now to FIG. 2, a block diagram of a data processing system is depicted in accordance with an advantageous embodiment. In this illustrative example, data processing system 200 includes communications fabric 202 provides communications between processor unit 204, memory 206, persistent storage 208, communications unit 210, I/O unit 212, and display 214.

Processor unit 204 serves to execute instructions for software that may be loaded into memory 206. Processor unit 204 may be a set of one or more processors or may be a multi-processor core, depending on the particular implementation. Further processor unit 204 may be implemented using one or more heterogeneous processor systems in which a main processor is present with secondary processors on a single chip. Memory 206, in these examples, may be, for example, a random access memory. Persistent storage 208 may take various forms depending on the particular implementation. For example, persistent storage 208 may be, for example, a hard drive, a flash memory, a rewritable optical disk, a rewritable magnetic tape, or some combination of the above.

Communications unit 210, in these examples, provides for communications with other data processing systems or devices. In these examples, communications unit 210 is a network interface card. I/O unit 212 allows for input and output of data with other devices that may be connected to data processing system 200. For example, I/O unit 212 may provide a connection for user input through a keyboard and mouse. Further, I/O unit 212 may send output to a printer. Display 214 provides a mechanism to display information to a user.

Instructions for the operating system, the object-oriented programming system, and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206.

FIG. 2 is intended as an example, and not as an architectural limitation for different embodiments. The hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 206. A processing unit may include one or more processors or CPUs. The depicted examples in FIG. 2 and above-described examples are not meant to imply architectural limitations. For example, data processing system 200 also may be a tablet computer, laptop computer, or telephone device in addition to taking the form of a PDA.

Turning now to FIG. 3, a block diagram of a teleconferencing system is depicted in accordance with an illustrative embodiment. A teleconferencing system, such as teleconferencing system 114 in FIG. 1 can be implemented using data processing system 300, which can be implemented using data processing system 200 depicted in FIG. 2. In an exemplary teleconferencing system implemented in this manner, bridge application 301 can be loaded into memory 306 of the data processing system 300, which can be implemented using memory 206 in FIG. 2. Bridge administration application 307, separate from or combined with bridge application 301, can also be loaded into memory 306.

The applications in the memory use communication unit 310, which can be implemented using communication unit 210 in FIG. 2, for communicating with equipment used by participants. For example, telephone interface device 312, which provides simultaneous telephone connectivity to a number of participants, may be accessible to bridge application 301 through communication unit 310. Additionally, communication unit 310 may provide bridge application 301 connectivity to participants using computers to connect to a teleconference.

The applications in memory 306 can use display 314, which is implemented using display 214 in FIG. 2, to enable an administrator to perform administration of the bridge and the teleconference. An administrator may or may not be needed depending on the specific implementation of the bridge and the nature of the teleconference.

Depictions in FIG. 3 are only exemplary and not intended to be limiting on the illustrative embodiments. Other configurations for a bridge and other methods for conducting a teleconference will become apparent to those of ordinary skill in the art from this disclosure.

During a teleconference, when several participants start to speak at the same time, confusion, noise, and annoyance results for all participants. A participant may want to interrupt another speaking participant but the interruption may not be accepted, received, or responded to, by the currently speaking participant. In such a case, the interrupting participant has to either forego the opportunity to speak, or speak over the currently speaking participant.

Presently, bridges provide only a rigid control of teleconferences to manage such issues. For example, the bridge may disable speaking capability for all participants except the currently speaking participant, and only allow other participants to speak at the end of the teleconference, such as in a question and answer session.

Illustrative embodiments recognize that if the interruptions in a teleconference, such as the one described above, are not managed at a more granular level, the teleconference may be ineffective, or worse, can degrade into a confusing and frustrating experience for all participants. The illustrative embodiments illustrate a method and system of prioritization of teleconference participants. Using the prioritization of the participants, teleconference functions can be more effectively allocated to the participants. For example, a participant can indicate intent to interrupt the currently speaking participant instead of simply beginning to speak simultaneously with the currently speaking participant. The bridge can then evaluate the intended interruption based on the priorities of the currently speaking participant and the interrupting participant, and provide a smooth transition from one participant to another.

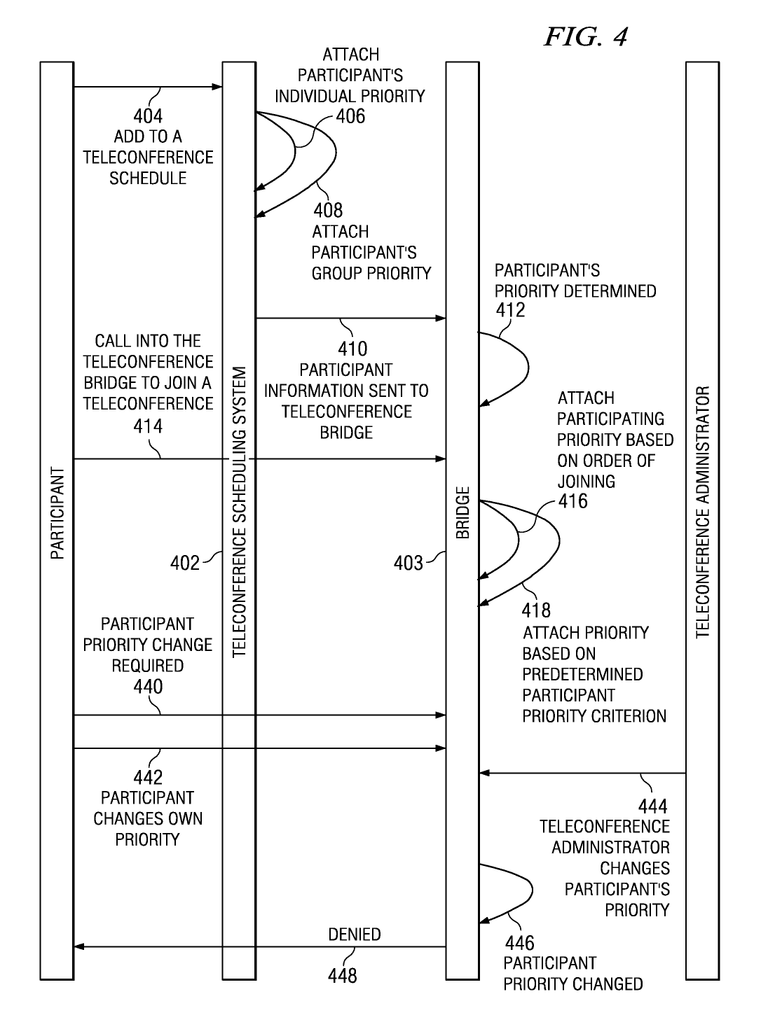

With reference now to FIG. 4, a message flow diagram of the process for determining and changing participant priority is depicted in accordance with an illustrative embodiment. A participant is identified to participate in a teleconference. The participant can be a participant using telephone equipment, such as telephone 102, telephone 104, telephone 106, telephone 108, or telephone 110 in FIG. 1. The participant may alternatively be a participant using a data processing system, such as data processing system 116 in FIG. 1.

Priority of the participant can be determined in at least two ways as shown. In a first manner of determination, the participant is added to a schedule of a teleconference (message 404). Schedule of a teleconference is created, maintained, or updated using teleconference scheduling system 402, which can be implemented using teleconference scheduling system 118 in FIG. 1.

Either an individual priority is associated with the participant (step 406), or a priority of the group to which the participant belongs is associated with the participant (step 408). For example, “consultants” may be a group to which the participant belongs, and the “consultants” group as a whole may have a priority for a teleconference, which is associated with each member of the group who joins the teleconference. Individual priority, or group priority, which ever is associated with participant in step 406 or 408, is then sent to the teleconferencing system or bridge 403 (message 410). Bridge 403 can be implemented using teleconferencing system 114 in FIG. 1. Thus, participant priority is determined at the teleconferencing system (step 412).

Alternatively, the participant may call into the teleconferencing system to join a present or future teleconference (message 414). The teleconferencing system may associate a priority with the participant either by the order of joining the teleconference (step 416), or by some pre-determined priority criteria (step 418). Either way, a priority for the participant is determined as in step 412. These methods of determining participant priority are exemplary and not intended to be limiting on the illustrative embodiments. Other ways of determining participant priority will become apparent to those of ordinary skill in the art from this disclosure.

Once participant priority is determined in step 412, a request to change the participant priority can also be made (message 440). Under some teleconference circumstances, a participant may be able to change the participant's own priority (message 442). Alternatively, a teleconference administrator or an equivalent entity may take the change request and change a participant's priority (message 444). A teleconference administrator is an administrator of the teleconference system and a user of bridge administration application 307 and display for administrator 314 in FIG. 3.

Using either of these alternative messages, message 442 or message 444, the participant's priority is changed in the teleconferencing system (step 446). A request to change the participant priority made in step 440 may also be denied (message 448). Again, additional ways for changing a participant's priority will become apparent to those of ordinary skill in the art from the disclosure.

With reference now to FIG. 5, a flowchart of the process of managing interruptions in a teleconference using participant priority is depicted in accordance with an illustrative embodiment. The process may be implemented in a bridge, such as bridge application 301 in FIG. 3.

The process begins with identifying that a participant is currently speaking in a teleconference (step 502). The process then identifies that a second participant has indicated intent to interrupt the currently speaking participant (step 504). A participant may indicate such intent by a predetermined method for the particular bridge used. For example, the participant may press number 1 on the telephone keypad to make such indication. As another example, the participant may press the “#” key to indicate that the participant wants to become the exclusive speaking participant. An exclusive speaking participant is a participant who is the sole speaker for a duration, or on a topic. Other methods for indicating such intent will be obvious to those of ordinary skill in the art depending upon the specific bridge implementation used.

Next, the process determines whether the second or interrupting participant can interrupt the speaking participant (step 506). One method for this determination is by comparing the priorities associated with the speaking participant and the interrupting participant. If the priority of the interrupting participant is higher than the priority of the speaking participant, the process determines that the interrupting participant can be allowed to interrupt.

Alternatively, if the priority of the interrupting participant is lower or equal to that of the speaking participant, the determination whether to allow the interruption can be made using a set of rules. For example, if the interrupting participant has lower priority but is also a designated speaking participant for some part of the teleconference, the interruption may be allowed. As another example, if the interrupting participant has attempted to interrupt a preset number of times, the interruption may be allowed. These rules are described only as examples and are not intended to be limiting on the illustrative embodiments. Other rules will become apparent to persons of ordinary skill in the art from this disclosure.

Another method of determining whether to allow the interruption is by determining the privileges assigned to the interrupting participant at the bridge, based on the priority of the interrupting participant. A privilege is an ability to take some action or cause some event to occur with respect to the teleconference. As an example, a privilege may be that the participant can interrupt at any time by virtue of his priority as the manager of all the participants on the teleconference. As another example, a privilege may be that the participant is an authority on the subject matter of the second half of the teleconference, and therefore can interrupt during the second half but not the first half. Note that a participant can have more than one privilege assigned to the participant. Furthermore, depending upon the specific implementation of the bridge, a privilege may be simply a copy of the priority of the participant, or may be derived from the priority of the participant.

Continuing with the description of FIG. 5, if the process determines that the interruption can be allowed, (“yes” path of step 506), the process identifies a method of interruption (step 508). For example, the bridge may allow the interrupting participant instant speaking access. Alternatively, the bridge may allow speaking access after a delay and after announcing to other participants that someone other than the currently speaking participant is about to speak. The bridge may also annunciate to the currently speaking participant that an interruption is requested, allowing the speaking participant to relinquish speaking control to the interrupting participant with decorum in an appropriate manner. Again, these examples of methods of interruption are only exemplary and are not intended to be limiting on the illustrative embodiments. Other methods of interruption will become apparent to those of ordinary skill in the art from this disclosure.

Furthermore, several methods of interruption may be available in a teleconferencing system and the process of selecting one of those methods can be an additional step in the process of FIG. 5. Such additional steps are teleconferencing system dependent and are not shown in FIG. 5 for the sake of clarity of description. FIG. 5 describes the process of utilizing participant priorities for allowing interruptions. Persons of ordinary skill in the art will be able to augment this process depending on the specific features of the teleconferencing system used.

Once the appropriate method of interruption is identified in step 508, the process allows the interrupting participant to interrupt and speak (step 510). The process ends thereafter. If the process determines that the interrupting participant cannot be allowed to interrupt, (“no” path of step 506), the process ends thereafter.

These illustrative embodiments describe the use of participant priorities for solving participant interruption problems in teleconferences. By assigning priorities to various participants, a basis for participant management is created. On this basis, teleconferences can proceed more smoothly and participants can avoid unnecessary interruptions.

Further, the participants can be better coordinated in gaining an opportunity to speak, resulting in a better overall teleconferencing experience for all participants. The description above depicts a selected few of the numerous ways in which participant priorities may be assigned and changed in a particular teleconferencing system. Many more system specific ways for implementing the illustrative embodiments will become apparent to those of ordinary skill in the art from this disclosure.

Additionally, the illustrative embodiments are described in terms of a voice teleconference for clarity. The illustrative embodiments can also be used for teleconferences that include video, collaborative documents and workspaces, and web-based teleconferencing features. Many other forms of teleconferences involving multiple participants, where the illustrative embodiments are useful for prioritizing those participants, will become apparent to those of ordinary skill in the art from this disclosure.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the illustrative embodiment has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a teleconference, the computer implemented method comprising:
identifying priority levels for a plurality of participants for the teleconference;
identifying a current participant in the teleconference, wherein the current participant is currently communicating with the plurality of participants;
monitoring for an indication that another participant in the plurality of participants desires to interrupt the current participant;
comparing a first priority level in the priority levels for the current participant with a second priority level in the priority levels for the another participant to form a comparison; and
selectively allowing the another participant to interrupt the current participant based on the comparison.

2. The computer implemented method of claim 1, wherein the priority levels for the plurality of participants are determined during one of organizing the teleconference, joining the teleconference, and the teleconference in progress, and wherein the priority levels for the plurality of participants can be modified at any time prior to the end of the teleconference.

3. The computer implemented method of claim 2, wherein a priority level of a participant in the priority levels of the plurality of participants is a priority level of a group to which the participant belongs.

4. The computer implemented method of claim 1, wherein using the ability to interrupt the teleconference granted to the another participant, the another participant can at least one of, interrupt the current participant where the current participant has a lower priority, interrupt the current participant where the current participant has a higher priority under specific conditions, and become an exclusive speaking participant for a duration.

5. A computer program product comprising a computer usable medium including computer usable code for managing a teleconference, the computer program product comprising:
computer usable code for identifying priority levels for a plurality of participants for the teleconference;
computer usable code for identifying a current participant in the teleconference, wherein the current participant is currently communicating with the plurality of participants;
computer usable code for monitoring for an indication that another participant in the plurality of participants desires to interrupt the current participant;
computer usable code for comparing a first priority level in the priority levels for the current participant with a second priority level in the priority levels for the another participant to form a comparison; and
computer usable code for selectively allowing the another participant to interrupt the current participant based on the comparison, wherein based on the comparison, the another participant can at least one of, interrupt the current participant where the current participant has a lower priority, interrupt the current participant where the current participant has a higher priority under specific conditions, and become an exclusive speaking participant for a duration.

6. The computer program product of claim 5, wherein the priority levels for the plurality of participants are determined during one of organizing the teleconference, joining the teleconference, and the teleconference in progress, and wherein the priority levels for the plurality of participants can be modified at any time prior to the end of the teleconference using the teleconferencing system.
